(19) United States
(12) Patent Application Publication
(10) Pub. No.: US 2009/0246468 A1
(43) Pub. Date: Oct. 1, 2009

(54) APPARATUS AND METHOD FOR MAKING REACTIVE POLYMER PRE-PREGS

(75) Inventor: Marcel J. Schubiger, Galgenen (CH)

Correspondence Address: GFD PATENTS, LLC, P.O. BOX 752, CLIFTON PARK, NY, 12065, US

(73) Assignee: IQ TEC SWITZERLAND GMBH, Galgenen (CH)

(21) Appl. No.: 12/414,241

(22) Filed: Mar. 30, 2009

Related U.S. Application Data
(60) Provisional application No. 61/040,710, filed on Mar. 30, 2008.

(51) Int. Cl. B32B 5/16; B05D 3/02; B05C 5/00

(52) U.S. Cl. 428/147; 427/195; 118/641

(57) ABSTRACT

A method and apparatus for making a reactive polymer pre-impregnated reinforcement material, comprising applying particles of a reactive thermoplastic resin to a first surface of a porous substrate at ambient temperature. The porous substrate may be impregnated by melting a first portion of the particles of the reactive thermoplastic resin. The first portion of the particles of the reactive thermoplastic resin flows into interstices of the first surface of the porous substrate and a remaining portion of the particles of the curable thermoplastic resin remains solid. An apparatus for forming a drapable polymer pre-impregnated reinforcement material, comprising: a feeder roll of reinforcement material, a receiver roll of drapable polymer pre-impregnated reinforcement material and a conveyor belt having the reinforcement material from the feeder roll thereon, and a particle deposition hopper adapted to deposit between 240 g/m² and about 470 g/m² of reactive thermoplastic particles.

This present patent application is a non-provisional application claiming priority to U.S. provisional application Ser. No. 61/040,710 (filed Mar. 30, 2008, entitled “Apparatus And Method For Making Reactive Polymer Pre-impregnated Reinforcement Materials From Polymer Granules And Polymerizing Same”).

### FIELD OF THE INVENTION

The present invention relates generally to an apparatus and method for making reactive polymer pre-impregnated reinforcement materials (pre-pregs). More specifically, the present invention relates to an apparatus and method for impregnating reinforcing materials, such as fibers, with resinous, monomeric, or macrocyclic materials. In one embodiment, the resinous, monomeric, or macrocyclic materials for making reactive polymer pre-impregnated reinforcement materials (pre-pregs) are low melt viscosity reactive thermoplastic compositions. The invention further provides a method for using such prepregs to form fully impregnated and consolidated thermoplastic composite sheets.

### BACKGROUND

There is a growing demand by industry, governmental regulatory agencies and consumers for durable and inexpensive products that are functional comparable or superior to metal products. This is particularly true in the automotive industry. Developers and manufacturers of these products are concerned with the strength parameters, such as impact, bending, stretching, and twisting resilience. To meet these demands, a number of reactive thermoplastic composite pre-pregs and thermoplastic based fully polymerized sheets have been engineered.

Therefore there is a need for an improved apparatus and method for making reactive polymer pre-impregnated reinforcement materials (pre-pregs).

### SUMMARY OF THE INVENTION

A first aspect of the present invention provides a method for making a reactive polymer pre-impregnated reinforcement material, comprising: applying particles of a reactive thermoplastic or thermoset resin having a melt viscosity between about 5 cp and about 5,000 cp to a first surface of a porous substrate to be pre-impregnated, wherein the particles of reactive thermoplastic or thermoset resin are applied to the first surface of the porous substrate at ambient temperature; and impregnating the porous substrate by melting by heating to a first temperature (T₁) over a first period of time (t₁) a first portion of the particles of the reactive thermoplastic or thermoset resin so that the first portion of the particles of the reactive thermoplastic or thermoset resin flows into interstices of the first surface of the porous substrate and a remaining portion of the particles of the curable thermoplastic or thermoset resin remains solid, wherein an area of the space between each particle is between about 2 mm² and about 200 mm² when the remaining portion is between about 0 and about 100% or substantially void free when the particle of reactive thermoplastic or thermoset resin has essentially completely melted.

A second aspect of the present invention provides a drapable polymer pre-impregnated reinforcement material, comprising: a porous substrate having a first surface; randomly spaced particles of a reactive thermoplastic, thereon, wherein a portion of each of the randomly spaced particles is impregnated into interstices of the first surface of the reinforcement material, therein, and wherein a space, therebetween, separates adjacent randomly spaced particles.

A third aspect of the present invention provides a method for forming a drapable polymer pre-impregnated reinforcement material, comprising: providing a porous substrate having a first surface; and forming an array of essentially uniformly spaced particles of a reactive thermoplastic having a melt viscosity between about 5 cp and about 5,000 cp., covering a portion of the first surface, thereon, wherein a portion of the reactive thermoplastic particles has been impregnated into interstices of a portion of the first surface of the reinforcement material, therein, and wherein a remaining portion of the first surface remains uncovered by the remaining portion of the reactive thermoplastic particle; and draping the polymer pre-impregnated reinforcement material.

A fourth aspect of the present invention provides an apparatus for forming a drapable polymer pre-impregnated reinforcement material, comprising: a feeder roll of reinforcement material, a receiver roll of drapable polymer pre-impregnated reinforcement material and a conveyor belt having the reinforcement material from the feeder roll thereon; a particle deposition hopper charged with reactive thermoplastic particles and adapted to deposit between 240 g/m² and about 470 g/m² of the reactive thermoplastic particles, based on the surface area (m²) of the reinforcement material; a thermal convection oven adapted to substantially uniformly maintain a temperature of the reactive thermoplastic particles on a first surface of the reinforcement material for a residence time, during which the reactive thermoplastic particles on the first surface of the reinforcement material reside in the oven; a conveyor belt wherein residence time that the reactive thermoplastic particles on the first surface of the reinforcement material is based on the conveyor belt's rate.

A fifth aspect of the present invention provides a method for forming a thermoplastic composite sheet, comprising: providing a feeder roll of reinforcement material, a receiver roll of drapable polymer pre-impregnated reinforcement material and a conveyor belt having the reinforcement material from the feeder roll thereon, wherein the reinforcement material has a fiber content based on total weight of the thermoplastic composite sheet; providing a particle deposition hopper charged with reactive thermoplastic particles and adapted to deposit between 240 g/m² and about 470 g/m² of the reactive thermoplastic particles, based on the surface area (m²) of the reinforcement material; providing a thermal convection oven adapted to substantially uniformly maintain the reactive thermoplastic particles on a first surface of the reinforcement material between about 190° C. and about 220° C. during a residence time that the reactive thermoplastic particles on a first surface of the reinforcement material reside in the oven; providing a conveyor belt wherein residence time that the reactive thermoplastic particles on the first surface of the reinforcement material is based on the conveyor belt's rate; and providing a belt press after the thermal convection oven, wherein the belt press has a hot zone and a cold zone, wherein the hot zone is adapted to receive drapable polymer pre-impregnated reinforcement material and to heat said pre-impregnated reinforcement material to less than or equal to 250° C. and greater than or equal to 1 bar pressure, and wherein the cold zone is adapted to receive a fully impregnated and cured thermoplastic composite sheet and to cool said fully impregnated and cured thermoplastic composite sheet to 25° C.

### BRIEF DESCRIPTION OF THE DRAWINGS

FIG. 1 depicts a longitudinal cross-sectional view of an apparatus for making a heat curable polymer pre-impregnated reinforcement material, according to embodiments of the present invention;

FIG. 2 depicts a longitudinal cross-sectional view of the apparatus taken along an axis 2-2 of FIG. 1, according to embodiments of the present invention;

FIG. 3A depicts a longitudinal cross-sectional view of the apparatus taken along an axis 3A-3A of FIG. 1, according to embodiments of the present invention;

FIG. 3B depicts a longitudinal cross-sectional view of the apparatus taken along an axis 3B-3B of FIG. 1, according to embodiments of the present invention;

FIG. 4 depicts a longitudinal cross-sectional view of an apparatus for pre-heating a first surface of a substrate of a prepreg, prior to thermally fixing particles of a reactive thermoplastic or thermoset resin on the first surface of the prepreg, according to embodiments of the present invention;

FIG. 5 depicts a longitudinal cross-sectional view of the apparatus taken along an axis 5-5 of FIG. 4, according to embodiments of the present invention;

FIG. 6A depicts a longitudinal cross-sectional view of the particle prepreg retrieval stage 237 of the apparatus 253 taken along an axis 6A-6A of FIG. 4;

FIG. 6B depicts a longitudinal cross-sectional view of the particle prepreg retrieval stage 237 of the apparatus 253 taken along an axis 6B-6B of FIG. 4; and

FIG. 7 is a flow diagram of a method for making a drapable or non-drapapable pre-preg, according to embodiments of the present invention.

### DESCRIPTION OF THE INVENTION

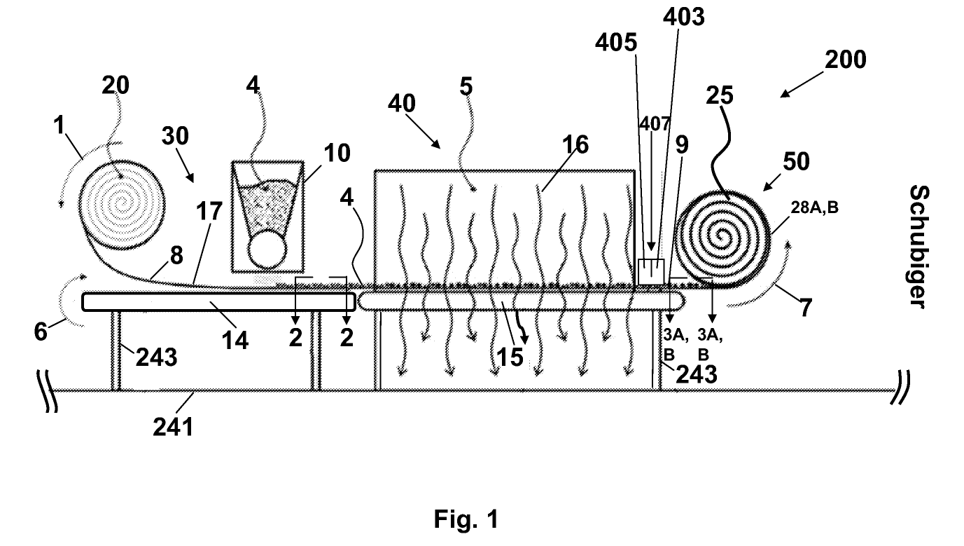

FIG. 1 is a schematic diagram illustrating a longitudinal cross-sectional view of an apparatus 200 for manufacturing a polymer pre-impregnated reinforcement material (prepreg) 28. The apparatus 200 comprises: a particle deposition stage 30, a thermal fixing stage 40, an optional belt press 407, and a prepreg retrieval stage 50.

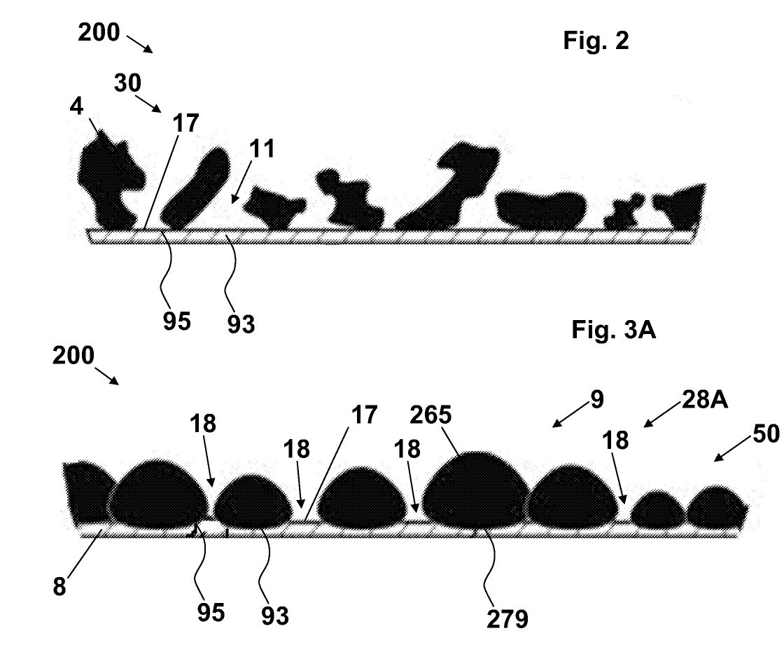

The particle deposition stage 30 comprises: a first steel-net conveyor belt 14; at least one supply roll(s) 20 for supplying a porous substrate 8; at least one hopper(s) 10 being charged with particles 4 of reactive (polymerizable) thermoplastic or thermoset resin; an array of particles 4 of reactive thermoplastic or thermoset resin deposited onto a first surface 17 of the porous substrate 8. The at least one supply roll(s) 20 may unroll by rotating in a direction of the arrow 1 about an axis orthogonal to a plane of the first surface 17 of the porous substrate 8. FIGS. 1-2 depict the particles 4 of reactive (polymerizable) thermoplastic or thermoset resin may advantageously be deposited onto the first surface 17 of the porous substrate 8, wherein both the particles 4 and the porous surface of the porous substrate 8 are advantageously at ambient temperature.

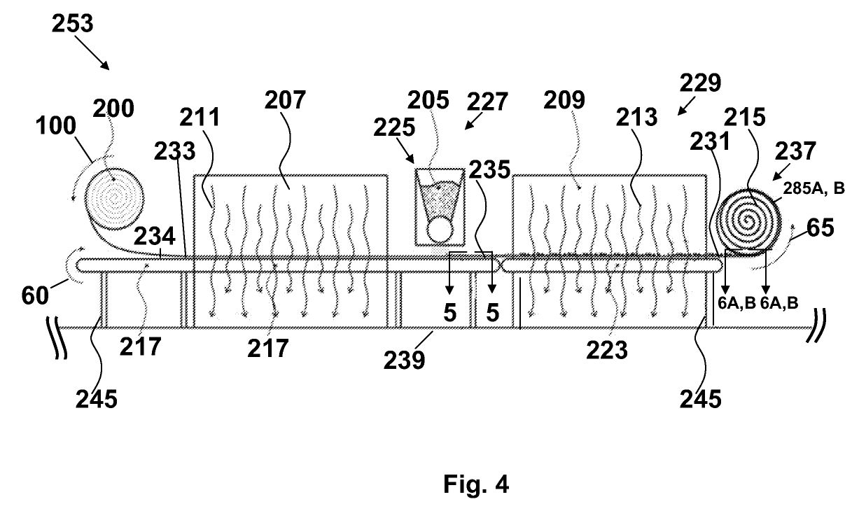

FIGS. 4-6 depict an alternative embodiment, in which the particles 205 of reactive (polymerizable) thermoplastic or thermoset resin may advantageously be deposited onto the first surface 234 of the porous substrate 233, wherein only the particles 205 are advantageously at ambient temperature, but the first surface 234 of the porous substrate 203 has been “pre-warmed”, to enable the particles 205 of the reactive thermoplastic or thermoset resin to adhere “immediately” to the first surface 234 of the porous substrate 233. In the embodiment depicted in FIGS. 4-6, and described in associated text, infra, the inventors report prevention of “rolling away”, or “blowing away” of the particles 205 when they are deposited onto the first surface 234 of the porous substrate 233 by pre-warming the first surface 234 of the porous substrate 233.

A range of particle size distribution of the particles 8, 205 of reactive (polymerizable) thermoplastic or thermoset resin may advantageously be greater than the range of particle size distribution of powders used in certain powder impregnation methods for infusing reactive thermoplastic powders into the interstices 93 between fibers 95, or fiber bundles, of the porous substrate 8, 205. In one embodiment the particles 8 of the reactive (polymerizable) thermoplastic or thermoset resin may advantageously be greater than between 150 to 1000 μm. In one embodiment the particles 8 of the reactive (polymerizable) thermoplastic or thermoset resin may advantageously have a diameter ranging from between 2 to 5 mm.

The thermal fixing stage 40 comprises: a second steel-net conveyor belt 15 for picking up the porous substrate 8 having the particles 4 of reactive (polymerizable) thermoplastic or thermoset resin, thereon, from the first steel-net conveyor belt 14 to convey the particles 4 into oven 5. The oven 5 may provide hot air laminar flow 16, warming the porous substrate 8 having the particles 4 of the reactive (polymerizable) thermoplastic or thermoset resin thereon and the second steel net conveyor 15. The oven 5 may be any appropriate heating device capable of raising the temperature of the substrate 8 between about 190° C. and 220° C. in a residence time between 1 and 5 minutes. In one embodiment, the porous substrate 8 may be a fiber reinforcement fabric, a glass mat, or a fiber bed.

The apparatus 200 may optionally be equipped with a belt press 407 after the thermal convection oven 5, 209, wherein the belt press has a hot zone 405 and a cold zone 403, wherein the hot zone 405 is adapted to receive drapable polymer pre-impregnated reinforcement material 28B, 285B and to heat said pre-impregnated reinforcement material 28B, 285B to less than or equal to 250° C. and greater than or equal to 1 bar pressure, and wherein the cold zone 403 is adapted to receive a fully impregnated and cured thermoplastic composite sheet and to cool said fully impregnated and cured thermoplastic composite sheet to 25° C.

The first and second steel-net conveyor belts 14, 15 may be supported by legs 243 that rest on manufacturing floor 241. The first and second steel-net conveyor belts 14, 15 may rotate in a direction of the arrow 6 to carry the porous substrate 8 having the particles 4 of reactive (polymerizable) thermoplastic or thermoset resin, thereon, from the first steel-net conveyor belt 14 to convey the particles 4 into oven 5.

The prepreg retrieval stage 50 comprises: at least one retrieving roll(s) 25 for retrieving the prepreg 28; a prepreg 28, wherein the prepreg 28 comprises the porous substrate 8 from supply roll 20, and an array 9 of thermally fixed particles, thereon. The at least one retrieving roll(s) 25 may retrieve the prepreg 28 by rotating in a direction of the arrow 7 about an axis orthogonal to a plane of the first surface 17 of the porous substrate 8.

FIG. 2 depicts a longitudinal cross-sectional view of the particle distribution stage 30 of the apparatus 200 taken along an axis 2-2 of FIG. 1. FIG. 2 depicts first surface 17 of the porous substrate 8, on which the particles 4 of reactive (polymerizable) thermoplastic or thermoset resin have been deposited, thereon. The porous substrate 8 comprises a first surface 17, having particles 4, thereon, and spaces 11, therebetween. In one embodiment, the porous substrate 8 is a fiber reinforced fabric, or a fiber bed, and the particles 4 of the reactive (polymerizable) thermoplastic or thermoset resin, thereon, are granules. A particle size distribution of the particles 8 of reactive (polymerizable) thermoplastic or thermoset resin may advantageously be greater than the range of particle size distribution of powders used in certain powder impregnation methods for infusing reactive (polymerizable) thermoplastic powders into the interstices 93 between fibers 95 or fiber bundles of the porous substrate 8. In one embodiment the particles 4 of the reactive (polymerizable) thermoplastic or thermoset resin may advantageously be greater than between 150 to 1000 μm. In one embodiment the particles 4 of the reactive (polymerizable) thermoplastic or thermoset resin may advantageously have a diameter ranging from between 2 to 5 mm. In one embodiment, a shape of the particles 4 of the thermoplastic or thermoset resin may be a granule, pellet, flake, pastille, needle, chunks, or a chip.

Hereinafter, a “granule” is defined as a particle larger than a sand grain and smaller than a pebble, between 2 mm and 4 mm in diameter.

Hereinafter a “pellet” is defined as a small rounded, spherical, or cylindrical body, having a diameter between about 2 mm and 5 mm.

Hereinafter a “flake” is defined as a particle having a surface area greater than 2 mm² and a thickness between 0.02 mm and 0.1 mm.

Hereinafter, a “pastille” is an enrobed active catalytic thermoplastic or thermoset resin material with a protective coating. The pastille may be prepared using a low-shear jacketed blender and a pastillator. The resultant pastille varies in shape and has a diameter of from about 2 mm to about 100 mm and a thickness of 1 mm to 10 mm.

Hereinafter a “needle” is defined as narrow and long and pointed; as pine leaves.

Hereinafter a “chunk” is defined as a short, thick piece or lump.

Hereinafter a “chip” is defined as a small fragment of reactive (polymerizable) thermoplastic or thermoset resin broken off from the whole.

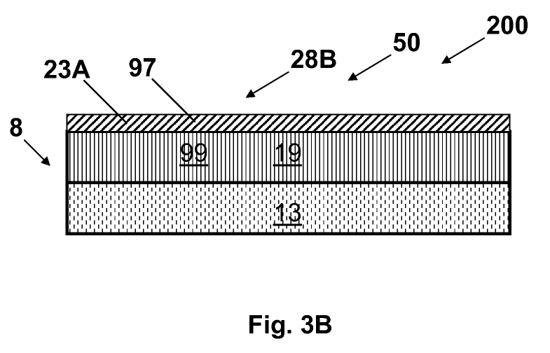

FIG. 3A depicts a longitudinal cross-sectional view of the particle prepreg retrieval stage 50 of the apparatus 200 taken along an axis 3A-3A of FIG. 1. FIG. 3A depicts a drapable prepreg 28. The prepreg 28 is drapable because an array 9 of thermally fixed particles 265 are thermally fixed by partially melting the particles 4 of reactive (polymerizable) thermoplastic or thermoset resin shown in FIG. 2. The partially melted reactive (polymerizable) thermoplastic or thermoset resin particles 265, shown in FIG. 3A, may flow into the interstices 93 between the fibers 95 or fiber bundles of the porous substrate 8, resulting in the particles 265 becoming thermally fixed to the fibers or fiber bundles of the porous substrate 8 when the reactive (polymerizable) thermoplastic or thermoset resin crystallizes or resolidifies when the prepreg 28 cools below the melting point of the reactive (polymerizable) thermoplastic or thermoset resin after coming out of oven 5 on cooling in the prepreg 28 retrieval stage 50. The prepreg 28 is drapable because an array 9 of thermally fixed particles 265 are thermally fixed to the first surface 17, thereon, and separated by spaces 18. Alternatively, a non-drapable prepreg 28 may be formed by completely melting the low melt viscosity reactive (polymerizable) thermoplastic or thermoset resin particles 4 in oven 5 to form particles 265.

FIG. 3B depicts a longitudinal cross-sectional view of the particle prepreg retrieval stage 50 of the apparatus 200 taken along an axis 3B-3B of FIG. 1. The prepreg 28A, shown in FIG. 3B, may be non-drapable because an at least one layer(s) 97, 19 of reactive (polymerizable) thermoplastic or thermoset resin has been formed that does not have voids. In one embodiment, the reactive (polymerizable) particles 4, shown in FIGS. 1-2, have been completely melted to form a layer 97 of reactive (polymerizable) thermoplastic or thermoset resin. A first portion 99 of the layer 97 may be impregnated or impressed into the interstices 93 between fibers 95 or fiber bundles of the porous substrate 8, shown in FIGS. 2, 3A. The impressed or impregnated first portion 99 of the layer 97 may form a layer 19, in which the reactive (polymerizable) thermoplastic or thermoset resin has been thermally fixed onto the fibers 93 or fiber bundles. The completely melted layer 97 may have flowed into the spaces 18 between the particles 265 of the array 9, shown in FIG. 3A, to become the layers 97 and/or 19. In another embodiment, the completely melted reactive (polymerizable) thermoplastic or thermoset resin layer 97 has melted and extends essentially completely into the substrate 8, forming the layers 19 and 13 in the substrate 8. Hereinafter, “thermally fixed” means reactive functionalities of the reactive (polymerizable) thermoplastic or thermoset resin particles 265 have become chemically bonded or attracted by Van der Wahls forces or other attractive intermolecular forces to the fibers 95 or fiber bundles of the substrate 8 during the melting process.

FIG. 3B depicts a prepreg 28B that is non-drapable because a first portion 97 of the completely melted reactive (polymerizable) thermoplastic or thermoset resin 265 has flowed into interstices 93 between fibers 95 or fiber bundles of the porous substrate 8, so that some of the melt impregnates or impresses between and among the fibers 95 or fiber bundles of the porous substrate 8, forming at least one layer 13, 19 of reactive (polymerizable) thermoplastic or thermoset resin in the porous substrate 8. A remaining portion 99 of the completely melted reactive (polymerizable) thermoplastic or thermoset resin 265 that doesn't flow into the interstices between fibers or fiber bundles of he porous substrate 8 forms the layer 23A which lies upon the first surface 17 of the porous substrate 8.

Void free laminates or composite structures may be made from drapable or non-drapable reactive (polymerizable) polymer pre-impregnated reinforcement materials (prepregs) 28. The non-drapable reactive (polymerizable) polymer pre-impregnated reinforcement materials (prepregs) 28 may be at least one layer 13, 19 or 23A of low melt viscosity reactive (polymerizable) thermoplastic or thermoset resin, having been completely melted when thermally fixed or compression molded. The combination of heat and pressure may force the low viscosity reactive (polymerizable) thermoplastic or thermoset resin to penetrate the fibers 95 or fiber bundles of the porous substrate 8 to form at least one layer 13, 19.

In one embodiment, the particles 265 of the reactive (polymerizable) thermoplastic or thermoset resin on the first surface 17 of the porous substrate 8 are reactive (polymerizable) thermoplastic or thermoset resin granules placed on top of a fiber bed and partly fused into fiber bundles of the fiber bed by impregnating particles 4 of a reactive (polymerizable) thermoplastic or thermoset resin into interstices 93 between fibers 95 in the fiber bundles of the fiber bed. Hereinafter, reactive (polymerizable) thermoplastic or thermoset resin is defined as the particles 4 of the reactive (polymerizable) thermoplastic or thermoset resin on the first surface 17 of the porous substrate 8, which can subsequently be partially polymerized or fully polymerized.

FIG. 4 depicts a longitudinal cross-sectional view of an apparatus 253 for manufacturing a polymer pre-impregnated reinforcement material (prepreg) 287. Specifically, the apparatus 253 may be for pre-heating a first surface 233 of a porous substrate 234 of a prepreg 287, prior to thermally fixing particles 205 of a reactive thermoplastic or thermoset resin on the first surface 233 of the prepreg 285.

The apparatus 253 comprises: a combined particle deposition and a thermal fixing stage 227, a prepreg finishing stage 229, and a prepreg retrieval stage 237. The at least one supply roll(s) 200 of the combined particle deposition and a thermal fixing stage 227 may unroll by rotating in a direction of the arrow 100 about an axis orthogonal to a plane of the first surface 233 of the porous substrate 234.

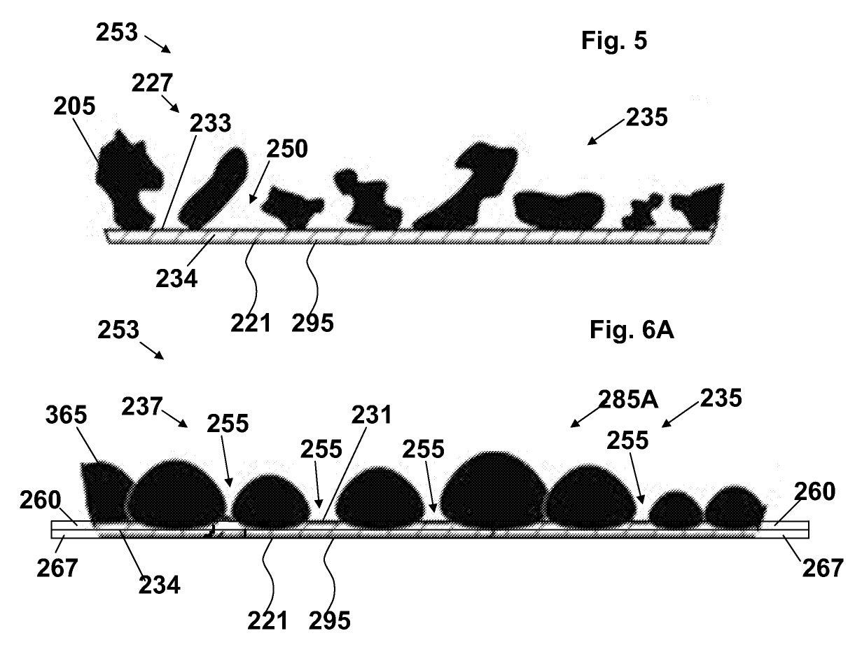

FIG. 5 depicts a longitudinal cross-sectional view of the apparatus taken along an axis 5-5 of FIG. 4. FIGS. 4-5 depict the particles 205 of reactive (polymerizable) thermoplastic or thermoset resin may advantageously be deposited onto the first surface 234 of the porous substrate 233, wherein the first surface 233 of the porous substrate 234 has been advantageously heated to at least 90° C. before the particles 205 being at ambient temperature have been deposited thereon.

FIG. 4 depicts an embodiment, in which the particles 205 of reactive (polymerizable) thermoplastic or thermoset resin may advantageously be deposited onto the first surface 233 of the porous substrate 234, wherein only the particles 205 are advantageously at ambient temperature, but the first surface 233 of the porous substrate 204 has been “pre-warmed”, to enable the particles 205 of the reactive (polymerizable) thermoplastic or thermoset resin to adhere “immediately” to the first surface 233 of the porous substrate 234. In the embodiments depicted in FIGS. 4-5, and described in associated text, infra, the inventors report prevention of “rolling away”, or “blowing away” of the particles 205 when they are deposited onto the first surface 233 of the porous substrate 234 by pre-warming the first surface 233 of the porous substrate 234.

The combined particle deposition and a thermal fixing stage 227 comprises: a first steel-net conveyor belt 217; at least one supply roll(s) 200 for supplying a porous substrate 234; at least one hopper(s) 225 being charged with particles 205 of reactive (polymerizable) thermoplastic or thermoset resin; a thermally fixed array of particles 235 of reactive (polymerizable) thermoplastic or thermoset resin deposited onto a first surface 233 of the porous substrate 234. The combined particle deposition and a thermal fixing stage 227 includes a pre-warming oven 207 for pre-warming the first surface 233 of the porous substrate 234, so a first portion the particles 205 may be thermally fixed to the first surface 233 of the porous substrate 234 when the particles 205 are randomly deposited on the first surface 233 of the porous substrate 234, so that the particles 205 may be thermally fixed as the array of particles 235. In this embodiment of the invention “rolling away”, or “blowing away” of the particles 205 is prevented when the particles 205 are deposited onto the first surface 233 of the porous substrate 234 by pre-warming the first surface 233 of the porous substrate 234.

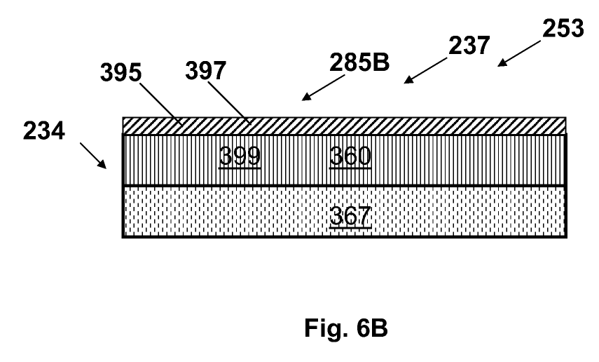

A range of particle size distribution of the particles 205 of reactive (polymerizable) thermoplastic or thermoset resin may advantageously be greater than the range of particle size distribution of powders used in certain powder impregnation methods for infusing reactive (polymerizable) thermoplastic powders into the interstices 295 between fibers 221 or fiber bundles of the porous substrate 234, as depicted in FIGS. 5, 6A, and 6B and described in associated text herein. In one embodiment, the particles 205 of the reactive (polymerizable) thermoplastic or thermoset resin may advantageously be greater than between 150 to 1000 μm. In one embodiment the particles 205 of the reactive (polymerizable) thermoplastic or thermoset resin may advantageously have a diameter ranging from between 2 to 5 mm.

The prepreg finishing stage 229 comprises: a second steel-net conveyor belt 223 for picking up the porous substrate 234 having the thermally fixed array of particles 235 of reactive (polymerizable) thermoplastic or thermoset resin, thereon, from the first steel-net conveyor belt 217 to convey the thermally fixed array of particles 235 into oven 209. The oven 209 may provide hot air laminar flow 213 to the porous substrate 234 having the thermally fixed array of particles 235 of the reactive (polymerizable) thermoplastic or thermoset resin thereon and to the second steel net conveyor 223. The oven 209 may be any appropriate heating device capbable of raising the temperature of the porous substrate 234 between about 190° C. and 220° C. in a residence time between about 1 and about 5 minutes. In one embodiment, the porous substrate 234 is a fiber reinforcement fabric, a glass mat, or a fiber bed.

The first and second steel-net conveyor belts 217, 223 may be supported by legs 245 that rest on manufacturing floor 239. The first and second steel-net conveyor belts 217, 223 may rotate in a direction of the arrow 60 to carry the porous substrate 234 having the thermally fixed array of particles 235 of reactive (polymerizable) thermoplastic or thermoset resin, thereon, from the first steel-net conveyor belt 217 to convey the thermally fixed array of particles 235 into oven 209.

The prepreg retrieval stage 237 comprises: a retrieving roll 215 for retrieving the prepreg 285; a prepreg 285, wherein the prepreg 285 comprises the porous substrate 234 from supply roll 200, and a thermally fixed particle array 231, thereon. The at least one retrieving roll(s) 215 may retrieve the prepreg 285 by rotating in a direction of the arrow 65 about an axis orthogonal to a plane of the first surface 233 of the porous substrate 234.

FIG. 5 depicts a longitudinal cross-sectional view of the combined particle deposition and a thermal fixing stage 227 of the apparatus 253 taken along an axis 5-5 of FIG. 4. FIG. 5 depicts a thermally fixed particle array 235. The prepreg 285 is drapable because the array 235 of thermally fixed particles 205 may be thermally fixed by partially melting the particles 205 of reactive (polymerizable) thermoplastic or thermoset resin which partially melt when the particles 205 touch or undergo heat transfer from the pre-warmed first surface 233 of the porous substrate 234. The melt from the partially melted reactive (polymerizable) thermoplastic or thermoset resin particles 205, shown in FIG. 5, may flow into the interstices 295 between the fibers 221 or fiber bundles of the porous substrate 234, resulting in the particles 205 becoming thermally fixed to the fibers 221 or fiber bundles in the first surface 233 of the porous substrate 234 when the reactive (polymerizable) thermoplastic or thermoset resin crystallizes or resolidifies when the thermally fixed particle array 235 cools below the melting point of the reactive (polymerizable) thermoplastic or thermoset resin after coming out of oven 207 of the combined particle deposition and thermally fixing stage 227. The prepreg 285 may be drapable because the array 235 of thermally fixed particles 205 are thermally fixed to the first surface 233, thereon, and separated by spaces 250.

FIG. 6A depicts a longitudinal cross-sectional view of the particle prepreg retrieval stage 237 of the apparatus 253 taken along an axis 6A-6A of FIG. 4. FIG. 6A depicts a drapable prepreg 285, having a thermally fixed particle array 235. The prepreg 285A is drapable because the array 235 of thermally fixed particles 205 may be thermally fixed by partially melting the particles 205 of reactive (polymerizable) thermoplastic or thermoset resin which partially melt when the particles 205 touch or undergo heat transfer from the pre-warmed first surface 233 of the porous substrate 234. The melt from the partially melted reactive (polymerizable) thermoplastic or thermoset resin particles 205, shown in FIG. 5, may flow into the interstices 295 between the fibers 221 or fiber bundles of the porous substrate 234, resulting in the particles 205 becoming thermally fixed to the fibers 221 or fiber bundles in the first surface 233 of the porous substrate 234 when the reactive (polymerizable) thermoplastic or thermoset resin crystallizes or resolidifies when the thermally fixed particle array 235 cools below the melting point of the reactive (polymerizable) thermoplastic or thermoset resin after coming out of oven 207 of the combined particle deposition and thermally fixing stage 227. The prepreg 285 may be drapable because the array 235 of thermally fixed particles 205 are thermally fixed to the first surface 233, thereon, and separated by spaces 250.

FIG. 6B depicts a longitudinal cross-sectional view of the particle prepreg retrieval stage 237 of the apparatus 253 taken along an axis 6B-6B of FIG. 4. The prepreg 285B, shown in FIG. 6B, may be non-drapable because an at least one layer(s) 397, 360 of reactive (polymerizable) thermoplastic or thermoset resin have been formed that do not have voids. In one embodiment, the reactive (polymerizable) particles 205, shown in FIGS. 4-5, have been completely melted to form a layer 397 of reactive (polymerizable) thermoplastic or thermoset resin. A portion 399 of the layer 397 may be impregnated or impressed into the interstices 295 between fibers 221 or fiber bundles of the porous substrate 234, shown in FIGS. 4, 6A may form a layer 360, in which the reactive (polymerizable) thermoplastic or thermoset resin has been thermally fixed onto the fibers 221 or fiber bundles and filled into the spaces 255 between the particles 365 of the array 235, shown in FIG. 6A, have flowed together to become the layer 360. In another embodiment, the completely melted reactive (polymerizable) thermoplastic or thermoset resin layer 97 has melted and extends essentially completely into the substrate 234, forming the layer 360 and 367 in the substrate 234. Hereinafter, “thermally fixed” means reactive functionalities of the reactive (polymerizable) thermoplastic or thermoset resin particles 205 have become chemically bonded or attracted by Van der Wahls forces or other attractive intermolecular forces to the fibers 221 or fiber bundles of the substrate 234 during the melting process. FIG. 6B depicts a prepreg 285B that is non-drapable because a first portion 399 of the completely melted reactive (polymerizable) thermoplastic or thermoset resin 397 has flowed into interstices 295 between fibers 221 or fiber bundles of the porous substrate 234, so that some of the melt impregnates or impresses between and among the fibers 221 or fiber bundles of the porous substrate 234, forming at least one layer 360, 367 of reactive (polymerizable) thermoplastic or thermoset resin in the porous substrate 234. A remaining portion 395 of the completely melted reactive (polymerizable) thermoplastic or thermoset resin that doesn't flow into the interstices between fibers or fiber bundles of the porous substrate 234 forms the layer 397 which lies upon the first surface 233 of the porous substrate 234.

Void free laminates or composite structures may be made from drapable or non-drapable reactive (polymerizable) polymer pre-impregnated reinforcement materials (prepregs) 285A, B. The non-drapable reactive (polymerizable) polymer pre-impregnated reinforcement materials (prepregs) 285A may be an at least one layer(s) 97, 19, and/or 13, as in FIG. 3B or 397, 360, and/or 367, as in FIG. 6B, of low melt viscosity reactive (polymerizable) thermoplastic or thermoset resin particles 4, 205, having been completely melted when thermally fixed or compression molded. The combination of heat and pressure may force the low viscosity reactive (polymerizable) thermoplastic or thermoset resin to penetrate the fibers 95, 221 through the porous substrate 8, 234.

Reactive (polymerizable) thermoplastic composite pre-pregs 28A, B, 285A, B and thermoplastic based fully polymerized sheets may be manufactured from powdered macrocyclic polyester oligomers using powder impregnation, or solvent or slurry based impregnation, or hot melt impregnation technologies. However, powder impregnation, or solvent or slurry based impregnation, or hot melt impregnation technologies are undesirable for the following reasons.

Using powders as precursor material is expensive, since grinding of typically available granules is an additional production step, which in the case of polyesters and polyamides has to happen under cryogenic temperatures. Also, powder impregnation followed by melting the powder forms a continuous thermoplastic layer that is not drapable.

Using solvent or slurry based methods have issues with evaporating the slurry carrier or solvent during the process, making these methods highly complicated and expensive.

Using hot melt technologies requires the use of complex melting, dosing and delivering systems such as extruders and rotoformers and also have the problem of having to initiate an advanced polymerization inside the delivery equipment before impregnating the fiber bed.

Therefore, there has been a long felt need for a process for making the pre-pregs 28A, B, 285A, B and thermoplastic based fully polymerized sheets that do not require powder impregnation, or solvent or slurry based impregnation, or hot melt impregnation technologies, in which low melt viscosity reactive (polymerizable) thermoplastic or thermoset resins particles 4, 205 are directly deposited onto a first surface 17, 233 of a porous substrate 8, 234 of the -pregs 28A, B, 285A, B and thermoplastic based fully polymerized sheets, thereon. In this process, which is an alternative to powder impregnation, or solvent or slurry based impregnation, or hot melt impregnation technologies, direct deposition of the low melt viscosity reactive (polymerizable) thermoplastic or thermoset resin particles 4, 205 onto the first surface 17, 233 of the porous substrate 8, 234 thereon, is followed by impregnating or impressing a portion or all of the low melt viscosity particles 4, 205 into the fibers or fiber bundles 95, 221 of the porous substrate 8, 234 by melting the reactive (polymerizable) thermoplastic or thermoset resin particles 4, 205 and optionally applying pressure. A process requiring that only ambient temperature resin particles 4, 205 be directly deposited onto the first surface 17, 233 of the porous substrate 8, 234 is preferred over processes requiring the reactive (polymerizable) thermoplastic or thermoset resin particles 4, 205 to be melted, slurried, commingled, or diluted with solvents, fillers, or plasticizers, before being deposited, because it is less expensive by avoiding these steps. Reactive (polymerizable) thermoplastic or thermoset resin particles 4, 205 having melt viscosities between about 5 cp and about 5,000 cp before being cured (polymerized) are commercially available from the Cyclics Corporation, Schenectady, N.Y. 12308, USA. CBT® 100 and CBT® 200 melt to water-like viscosity when heated, then polymerize into engineering thermoplastic PBT when catalyzed. CBT 100 features processing temperature between 190-240° C., while CBT 200 ranges from 170-240° C. Melting the particles 4, 205 before depositing the reactive (polymerizable) thermoplastic or thermoset resin particles 4 onto the first surface 17, 233 of the porous substrate 8, 234 has been used when it is necessary to melt thermoplastic or thermoset resins having higher melt viscosities than 5,000 cp in order to ensure the higher melt viscosity thermoplastic or thermoset resins come in close contact with the first surface 17, 233 of the porous substrate 8, 234 and the fibers and fiber bundles 95, 221 therein, such as a fiber bed before consolidation.

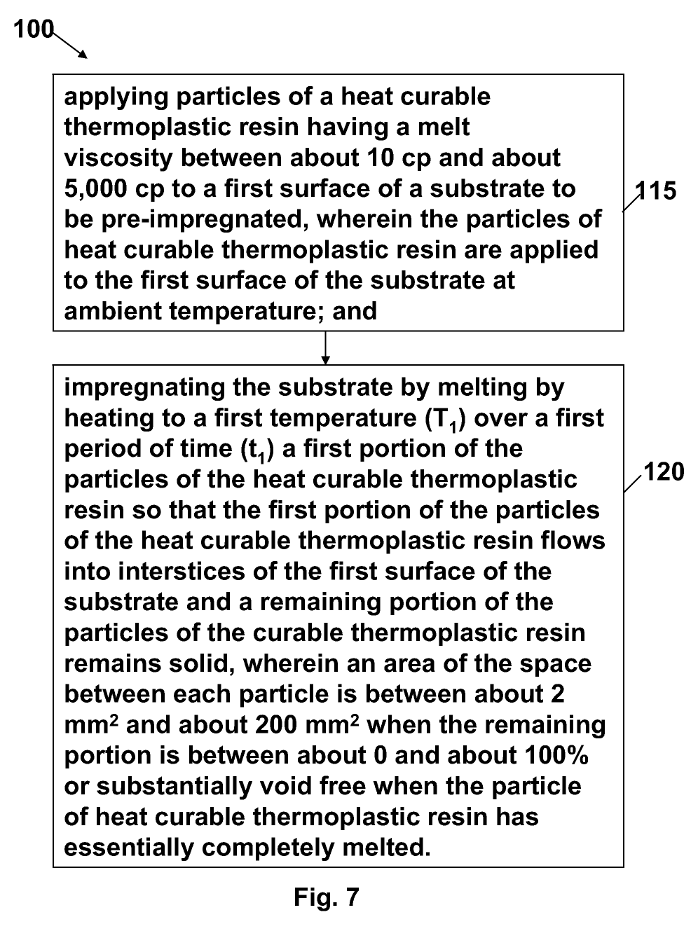

FIG. 7 depicts a flow sheet for a method 100 for making a reactive (polymerizable) polymer pre-impregnated reinforcement material. In a step 115 of the method 100 a reactive (polymerizable) thermoplastic or thermoset resin having a melt viscosity between about 5 cp and about 5,000 cp is applied to a first surface 117 of a porous substrate 8 to be pre-impregnated.

In one embodiment of the step 115 of the method 100, particles 4 of the heat curable thermoplastic or thermoset resin may be deposited onto the first surface 117 of the porous substrate 8 at ambient temperature from a hopper 10, such as a solid particle feeder.

In a step 120 of the method 100, the reactive (polymerizable) thermoplastic or thermoset resin is thermally fixed into interstices of the first surface of the porous substrate by partially melting a first portion of the curable thermoplastic or thermoset resin by heating to a first temperature T₁ over a first period of time t₁ so that the first portion of the reactive (polymerizable) thermoplastic flows into interstices of the porous substrate and a remaining portion of the curable thermoplastic or thermoset resin remains solid.

Fiber-reinforced plastic materials such as fiber-reinforced composites or fiber-reinforced laminates may be manufactured by first forming a reactive (polymerizable) polymer pre-impregnated reinforcement material (a “prepreg”), as in the method 100. In the method 100, the prepreg is formed by impregnating a fiber reinforcement material with a reactive (polymerizable) thermoplastic or thermoset resin.

In one embodiment, the method 100 may comprise a consolidating step, In which a plurality of prepregs are consolidated into a laminate, such as a reactive (polymerizable) thermoplastic or thermoset resin composite sheet. Fiber-reinforced plastic materials based on polyesters and nylon materials may be manufactured by first impregnating the fiber reinforcement with the thermoplastic or thermoset resin to form a prepreg, then consolidating one, two or more of the same into a laminate, like a thermoplastic composite sheet. In the consolidating step, consolidating may be necessary to fully impregnate the fiber reinforcement material, which may be laid out as a multi-layered bed before impregnation.

In one embodiment of the consolidating step of the method 100, the prepregs may be consolidated by applying heat and pressure. Higher temperatures and pressures are required to achieve substantially void free laminates by consolidation if the melt viscosity of the reactive (polymerizable) thermoplastic or thermoset resin is greater than between about 5 cp to about 5,000 cp.

Reactive (polymerizable) thermoplastic or thermoset resins having melt viscosities between about 5 cp and about 5,000 cp before being cured are commercially available from the Cyclics Corporation, Schenectady, N.Y. USA. Having a very low melt viscosity during processing, enables the reactive (polymerizable) thermoplastic or thermoset resins to impregnate a dense fibrous preform or bed more easily. Upon melting and in the presence of an appropriate catalyst, polymerisation occurs and the reactive (polymerizable) thermoplastic cures to form the laminate.

In one embodiment of the method 100, the reactive (polymerizable) thermoplastic or thermoset resin may be a blend of a polymerization catalyst and a linear polyester or a linear polyamide, wherein the polymerization catalyst is chosen so that the melt viscosity of the thermoplastic or thermoset resin characterizes its viscosity during the heating and impregnation steps 117, 120 of the method 100 to impregnate the reactive (polymerizable) thermoplastic or thermoset resin into the fiber reinforcement material.

In one embodiment of the method 100, the reactive (polymerizable) thermoplastic or thermoset resin may be a blend of a polymerization catalyst and a linear poly alkylene terephthalate (where the alkylene has between about 2 and about 8 carbon atoms) or a linear poly alkylene amide (where the alkylene has between about 4 and about 12 carbon atoms).

In one embodiment of the method 100, the reactive (polymerizable) thermoset resin may be an epoxy resin system such as a bifunctional epoxy (diglycidyl ether of bisphenol-A) matrix system.

In one embodiment of the method 100, the reactive (polymerizable) thermoset resin may be a reactive (polymerizable) unsaturated polyester resin or epoxy resin. Unsaturated polyester resins (USR) are the third-largest class of thermoset molding resins. The polyesters are low molecular weight viscous liquids dissolved in vinyl monomers like styrene to facilitate molding or shaping of the resin into a desired form before curing to rigid solids. Typical applications are in fiberglass-reinforced shower stalls, boat hulls, truck caps and airfoils, construction panels, and autobody parts and trim. Mineral-filled UPRs are used in synthetic marble countertops and autobody putty. Unfilled UPRs are used in gel coats and maintenance coatings. Adipic acid improves tensile and flexural strength in these resins and, at high levels, can give soft, pliable products for specialty applications. 1-Alkyd resins, a common type of unsaturated polyester resin, utilize adipic acid where low viscosity and high flexibility are valued in plasticizer applications. UPR resins are mainly aromatic polyesters. Flexibility of UPR is increased by replacing a portion of aromatic acid with adipic acid. A cure site monomer, like maleic anhydride, is incorporated to provide unsaturation within the polymer backbone. Crosslinking is by free radical addition polymerization of styrene monomer/diluent.

In one embodiment of the method 100, the reactive (polymerizable) thermoplastic or thermoset resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

In one embodiment of the method 100, the fiber reinforcement material may be carbon fiber, glass fiber, basalt fiber, and polymer fiber.

In a step 120 of the method 100, the reactive thermoplastic or thermoset resin is thermally fixed into interstices of the first surface of the porous substrate.

In the step 120, a first portion of the curable thermoplastic or thermoset resin is partially melted by heating to a first temperature T₁ over a first period of time t₁ so that the first portion of the reactive thermoplastic flows into interstices of the porous substrate and a remaining portion of the curable thermoplastic or thermoset resin remains solid.

In one embodiment of the method 100, a shape of the thermoplastic or thermoset resin is selected from the group consisting of a granule, pellet, flake, pastille, needle, chunks, and a chip.

In one embodiment of the method 100, the porous substrate is a reinforcement material selected from the group consisting of carbon fiber, glass fiber, basalt fiber, and polymer fiber.

In one embodiment of the method 100, the reinforcement material is in a form selected from the group consisting of roving, tape, web, weave, bi- or -multi-axial fabrics, knit, braid, random mat, and fleece.

In the step 120, in one embodiment, the first temperature is between about 190° C. and about 220° C. and the first period of time is between about 1 and 5 minutes.

In one embodiment of the method 100, a weight of the reinforcement material per surface area of the reinforcement material is between about 200 g/m² and about 4,000 g/m² and a weight percent of the reactive thermoplastic is between about 30% to about 80%, based on a weight of the reactive polymer pre-impregnated reinforcement material.

Hereinafter a reactive (polymerizable) thermoplastic or thermoset resin particle loading of 100 g/mm² equals 70 wt % on a 460 g/mm² GF fabric (the granule size needs to become smaller and smaller). 1000 g/mm² equals 30 wt % on a 810 g/mm² GF Fabric, respectively 38 wt % on a 810 g/mm² CF fabrc. This is always meant to be for “one layer per substrate”. 1700 g/m² for 4× layers of 810 g/m² GF; considering even fibre volume fraction as low as 30% up to 4000 g/m² resin have to be deposited.

In the step 120, in one embodiment, the first temperature is 190° C. and the first time period is less than or equal to 1 minute.

In one embodiment of the method 100, a weight of the reinforcement material persurface area of the reinforcement material is about 460 g/m² and a weight percent of the reactive thermoplastic is between about 34% to about 35%, based on a weight of the reactive polymer pre-impregnated reinforcement material.

In one embodiment of the method 100, a weight of the reinforcement material per surface area of the reinforcement material is about 620 g/m² and a weight percent of the reactive thermoplastic is between about 33% to about 36%, based on a weight of the reactive polymer pre-impregnated reinforcement materials.

In one embodiment of the method 100, a weight of the reinforcement material per surface area of the reinforcement material is about 810 g/m² and a weight percent of the reactive thermoplastic is between about 34% to about 36%, based on a weight of the reactive polymer pre-impregnated reinforcement material.

In one embodiment, the drapable polymer pre-impregnated reinforcement material pre-preg 28A, 285A comprises: a porous substrate 8, 234 having a first surface 17, 231; randomly spaced particles 4, 205 of a reactive thermoplastic, thereon, wherein a portion 99, 399 of each of the randomly spaced particles 4, 205 is impregnated into interstices 93, 295 of the first surface 17, 231 of the reinforcement material, therein, and wherein a space 11, 50 therebetween, separates adjacent randomly spaced particles 4, 205.

In one embodiment of the drapable polymer pre-impregnated reinforcement material (pre-preg) 28A, 285A, the reactive thermoplastic particles have a melt viscosity between about 5 cp and about 5,000 cp.

In one embodiment of the drapable polymer pre-impregnated reinforcement material (pre-preg) 28A, 285A, an area of the space between each particle is between about 2 mm² and about 200 mm²

In one embodiment of the drapable polymer pre-impregnated reinforcement material (pre-preg) 28A, 285A the particles have a diameter between about 1 mm to about 5 mm and a length between about 1 mm and about 8 mm.

In one embodiment of the drapable polymer pre-impregnated reinforcement material (pre-preg) 28A, 285A the particles have a thickness between 0.5 mm and 3 mm and a diameter between 1 mm and about 8 mm.

In one embodiment of the drapable polymer pre-impregnated reinforcement material (pre-preg) 28A, 285A the particles have a diameter between about 1 mm to about 8 mm and a length between about 1 mm and about 8 mm.

In one embodiment of the drapable polymer pre-impregnated reinforcement material (pre-preg) 28A, 285A the particles are made from macrocyclic oligomeric butyleneterephthalate.

In one embodiment of the drapable polymer pre-impregnated reinforcement material (pre-preg) 28A, 285A the particles have a diameter between about 1 mm and about 5 mm and a length between about 1 mm and about 8 mm.

In one embodiment, a method for forming a drapable polymer pre-impregnated reinforcement material (pre-preg) 28A, 285A, comprises: providing a porous substrate 8, 234 having a first surface 17, 231; and thermal fixing an array 9, 235 of essentially randomly spaced particles 4, 205 of a reactive thermoplastic having a melt viscosity between about 5 cp and about 5,000 cp., thereon

An apparatus 200, 253 for forming a drapable or non drapable polymer pre-impregnated reinforcement material (pre-preg), comprising: at least one feeder device 20, 200 of reinforcement material 8, 234; at least one receiver device 25, 215 of polymer pre-impregnated reinforcement material 8, 234; and at least one conveyor belt(s) 14, 15, 217, 223 having the reinforcement material 8, 234 from the at least one feeder device(s) 20, 200 thereon; a particle deposition hopper 10, 225 charged with reactive thermoplastic particles 4, 205 and adapted to deposit between 100 g/m² and about 1000 g/m² of the reactive thermoplastic particles 4, 205, based on the surface area (m²) of the reinforcement material 8, 234; at least one thermal convection oven 5, 209 adapted to substantially uniformly maintain a temperature of the reactive thermoplastic particles 4, 205 on a first surface 17, 231 of the reinforcement material 8, 234 for a residence time, during which the reactive thermoplastic particles 4, 205 on a first surface 17, 231 of the reinforcement material 8, 234 reside in the oven 5, 209; and at least one conveyor belt(s) 14, 15, 217, 223 wherein residence time that the reactive thermoplastic particles 4, 205 on the first surface 17, 231 of the reinforcement material 8, 234 is based on the conveyor belt's 14, 15, 217, 223 rate.

In one embodiment of the apparatus 200, 253 for forming a drapable or non drapable polymer pre-impregnated reinforcement material (pre-preg) 28A, B, 285A, B, the conveyor belt's 14, 15, 217, 223 rate is between about 1 meters per minute and about 4 meters per minute.

In one embodiment of the apparatus 200, 253 for forming a drapable or non drapable polymer pre-impregnated reinforcement material (pre-preg) 28A, B, 285A, B, the residence time that the reactive thermoplastic particles 4, 205 on a first surface 17, 231 of the reinforcement material 8, 234 reside in the oven 5, 209 is between about 1 min. and about 5 min.

In one embodiment of the apparatus 200, 253 for forming a drapable or non drapable polymer pre-impregnated reinforcement material (pre-preg), the reactive thermoplastic material is selected from the group consisting of reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

In one embodiment of the apparatus 200, 253 for forming a drapable or non drapable polymer pre-impregnated reinforcement material (pre-preg) 28A, B, 285A, B, a shape of the thermoplastic or thermoset resin is selected from the group consisting of a granule, pellet, flake, pastille, needle, chunks, and a chip.

In one embodiment of the apparatus 200, 253 for forming a drapable or non drapable polymer pre-impregnated reinforcement material (pre-preg) 28A, B, 285A, B, the porous substrate is a reinforcement material selected from the group consisting of carbon fiber, glass fiber, basalt fiber, and polymer fiber.

In one embodiment of the apparatus 200, 253 for forming a drapable or non drapable polymer pre-impregnated reinforcement material (pre-preg) 28A, B, 285A, B, the reinforcement material 8, 234 is in a form selected from the group consisting of roving, tape, web, weave, bi- or -multi-axial fabrics, knit, braid, random mat, and fleece.

In one embodiment of the apparatus 200, 253 for forming a drapable or non drapable polymer pre-impregnated reinforcement material (pre-preg) 28A, B, 285A, B, the temperature is between about 190° C. and about 220° C. and the residence time is between about 1 and 5 minutes.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is between about 200 g/m² and about 2,000 g/m² and a weight percent of the reactive thermoplastic is between about 30% to about 80%, based on a weight of the reactive polymer pre-impregnated reinforcement material.

In one embodiment of the apparatus 200, 253 for forming a drapable or non drapable polymer pre-impregnated reinforcement material (pre-preg) 28A, B, 285A, B, the temperature is 190° C. and the residence time is less than or equal to 1 minute.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is about 460 g/m² and a weight percent of the reactive thermoplastic is between about 34% to about 35%, based on a weight of the reactive polymer pre-impregnated reinforcement material.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is about 620 g/m² and a weight percent of the reactive thermoplastic is between about 33% to about 36%, based on a weight of the reactive polymer pre-impregnated reinforcement materials.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is about 810 g/m² and a weight percent of the reactive thermoplastic is between about 34% to about 36%, based on a weight of the reactive polymer pre-impregnated reinforcement material.

In one embodiment of the apparatus 200, 253 for forming a drapable or non drapable polymer pre-impregnated reinforcement material (pre-preg) 28A, B, 285A, B, the reactive thermoplastic particles 4, 205 have a thickness between 0.5 mm and 3 mm and a diameter between 1 mm and about 8 mm.

In one embodiment of the apparatus 200, 253 for forming a drapable or non drapable polymer pre-impregnated reinforcement material (pre-preg) 28A, B, 285A, B, the reactive thermoplastic particles 4, 205 have a diameter between about 1 mm to about 8 mm and a length between about 1 mm and about 8 mm.

In one embodiment of the apparatus 200, 253 for forming a drapable or non drapable polymer pre-impregnated reinforcement material (pre-preg) 28A, B, 285A, B, the reactive thermoplastic particles 4, 205 are made from macrocyclic oligomeric butyleneterephthalate.

In one embodiment of the apparatus 200, 253 for forming a drapable or non drapable polymer pre-impregnated reinforcement material (pre-preg) 28A, B, 285A, B, the reactive thermoplastic particles 4, 205 have a diameter between about 1 mm and about 5 mm and a length between about 1 mm and about 8 mm.

In one embodiment of the apparatus 200, 253 for forming a drapable or non drapable polymer pre-impregnated reinforcement material (pre-preg) 28A, B, 285A, B, comprises: a belt press after the thermal convection oven 5, 209, wherein the belt press has a hot zone and a cold zone, wherein the hot zone is adapted to receive drapable polymer pre-impregnated reinforcement material and to heat said pre-impregnated reinforcement material to less than or equal to 250° C. and greater than or equal to 1 bar pressure, and wherein the cold zone is adapted to receive a fully impregnated and cured thermoplastic composite sheet and to cool said fully impregnated and cured thermoplastic composite sheet to 25° C.

In one embodiment, a method for forming a thermoplastic composite sheet 28B, 285B, comprises: providing a feeder roll 20, 200 of reinforcement material 8, 234, a receiver roll 25, 215 of drapable polymer pre-impregnated reinforcement material 8, 234 and a conveyor belt 14, 217 having the reinforcement material 8, 234 from the feeder roll 20, 200 thereon, wherein the reinforcement material 8, 234 has a fiber content based on total weight of the thermoplastic composite sheet; providing a particle deposition hopper 10, 225 charged with reactive thermoplastic particles 4, 205 and adapted to deposit between 240 g/m² and about 470 g/m² of the reactive thermoplastic particles 4, 205, based on the surface area (m²) of the reinforcement material 8, 234;

In one embodiment, a method for forming a thermoplastic composite sheet 28B, 285B, comprises: providing a thermal convection oven 5, 209 adapted to substantially uniformly maintain the reactive thermoplastic particles 4, 205 on a first surface 17, 231 of the reinforcement material 8, 234 between about 190° C. and about 220° C. during a residence time that the reactive thermoplastic particles 4, 205 on a first surface 17, 231 of the reinforcement material 8, 234 reside in the oven 5, 209.

In one embodiment, a method for forming a thermoplastic composite sheet 28B, 285B, comprises: providing a conveyor belt 14, 217 wherein residence time that the reactive thermoplastic particles 4, 205 on the first surface 17, 231 of the reinforcement material 8, 234 is based on the conveyor belt's 14, 217 rate; and providing a belt press after the thermal convection oven 5, 209, wherein the belt press has a hot zone and a cold zone, wherein the hot zone is adapted to receive drapable polymer pre-impregnated reinforcement material 28B, 285B and to heat said pre-impregnated reinforcement material 28B, 285B to less than or equal to 250° C. and greater than or equal to 1 bar pressure, and wherein the cold zone is adapted to receive a fully impregnated and cured thermoplastic composite sheet and to cool said fully impregnated and cured thermoplastic composite sheet to 25° C.

In one embodiment of the method for forming a thermoplastic composite sheet 28B, 285B, the fiber content of the reinforcement material 8, 234 is between about 50% and about 70% by weight, based on a weight of the drapable polymer pre-impregnated reinforcement material 28B, 285B.

The foregoing description of the embodiments of this invention has been presented for purposes of illustration and description. It is not intended to be exhaustive or to limit the invention to the precise form disclosed, and obviously, many modifications and variations are possible.

I claim:

1. A method for making a reactive polymer pre-impregnated reinforcement material, comprising:
applying particles of a reactive thermoplastic resin having a melt viscosity between about 5 cp and about 5,000 cp to a first surface of a porous substrate to be pre-impregnated,
wherein the particles of reactive thermoplastic resin are applied to the first surface of the porous substrate at ambient temperature; and impregnating the porous substrate by melting by heating to a first temperature (T₁) over a first period of time (t₁) a first portion of the particles of the reactive thermoplastic resin so that the first portion of the particles of the reactive thermoplastic resin flows into interstices of the first surface of the porous substrate and a remaining portion of the particles of the curable thermoplastic resin remains solid,
wherein an area of the space between each particle is between about 2 mm² and about 200 mm² when the remaining portion is between about 0 and about 100% or substantially void free when the particle of reactive thermoplastic resin has essentially completely melted.

2. The method of claim 1, wherein the reactive thermoplastic resin is selected from the group consisting of reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

3. The method of claim 2, wherein a shape of the thermoplastic resin is selected from the group consisting of a granule, pellet, flake, pastille, needle, chunks, and a chip.

4. The method of claim 2, wherein the porous substrate is a reinforcement material selected from the group consisting of carbon fiber, glass fiber, basalt fiber, and polymer fiber.

5. The method of claim 4, wherein the reinforcement material is in a form selected from the group consisting of roving, tape, web, weave, bi- or -multi-axial fabrics, knit, braid, random mat, and fleece.

6. The method of claim 2, wherein the first temperature is between about 190° C. and about 220° C. and the first period of time is between about 1 and 5 minutes.

7. The method of claim 2, wherein a weight of the reinforcement material per surface area of the reinforcement material is between about 200 g/m² and about 2,000 g/m² and a weight percent of the reactive thermoplastic is between about 30% to about 80%, based on a weight of the reactive polymer pre-impregnated reinforcement material.

8. The method of claim 2, wherein the first temperature is 190° C. and the first time period is less than or equal to 1 minute.

9. The method of claim 2, wherein a weight of the reinforcement material per surface area of the reinforcement material is about 460 g/m² and a weight percent of the reactive thermoplastic is between about 34% to about 35%, based on a weight of the reactive polymer pre-impregnated reinforcement material.

10. The method of claim 2, wherein a weight of the reinforcement material per surface area of the reinforcement material is about 620 g/m² and a weight percent of the reactive thermoplastic is between about 33% to about 36%, based on a weight of the reactive polymer pre-impregnated reinforcement materials.

11. The method of claim 2, wherein a weight of the reinforcement material per surface area of the reinforcement material is about 810 g/m² and a weight percent of the reactive thermoplastic is between about 34% to about 36%, based on a weight of the reactive polymer pre-impregnated reinforcement material.

12. A drapable polymer pre-impregnated reinforcement material, comprising:
a porous substrate having a first surface;
randomly spaced particles of a reactive thermoplastic, thereon,
wherein a portion of each of the randomly spaced particles is impregnated into interstices of the first surface of the reinforcement material, therein, and
wherein a space, therebetween, separates adjacent randomly spaced particles.

13. The drapable polymer pre-impregnated reinforcement material of claim 12, wherein the reactive thermoplastic particles have a melt viscosity between about 5 cp and about 5,000 cp.

14. The drapable polymer pre-impregnated reinforcement material of claim 12, wherein an area of the space between each particle is between about 2 mm² and about 200 mm².

15. The drapable polymer pre-impregnated reinforcement material of claim 12, wherein the particles have a diameter between about 1 mm to about 5 mm and a length between about 1 mm and about 8 mm.

16. The drapable polymer pre-impregnated reinforcement material of claim 12, wherein the particles have a thickness between 0.5 mm and 3 mm and a diameter between 1 mm and about 8 mm.

17. The drapable polymer pre-impregnated reinforcement material of claim 12, wherein the particles have a diameter between about 1 mm to about 8 mm and a length between about 1 mm and about 8 mm.

18. The drapable polymer pre-impregnated reinforcement material of claim 12, wherein the particles are made from macrocyclic oligomeric butyleneterephthalate.

19. The drapable polymer pre-impregnated reinforcement material of claim 16, wherein the particles have a diameter between about 1 mm and about 5 mm and a length between about 1 mm and about 8 mm.

20. A method for forming a drapable polymer pre-impregnated reinforcement material, comprising:
providing a porous substrate having a first surface; and forming an array of essentially uniformly spaced particles of a reactive thermoplastic having a melt viscosity between about 5 cp and about 5,000 cp., covering a portion of the first surface, thereon,
wherein a portion of the reactive thermoplastic particles has been impregnated into interstices of a portion of the first surface of the reinforcement material, therein, and
wherein a remaining portion of the first surface remains uncovered by the remaining portion of the reactive thermoplastic particle;
draping the polymer pre-impregnated reinforcement material.

21. An apparatus for forming a drapable polymer pre-impregnated reinforcement material, comprising:
a feeder roll of reinforcement material, a receiver roll of drapable polymer pre-impregnated reinforcement material and a conveyor belt having the reinforcement material from the feeder roll thereon;
a particle deposition hopper charged with reactive thermoplastic particles and adapted to deposit between 240 g/m² and about 470 g/m² of the reactive thermoplastic particles, based on the surface area (m²) of the reinforcement material;
a thermal convection oven adapted to substantially uniformly maintain a temperature of the reactive thermoplastic particles on a first surface of the reinforcement material for a residence time, during which the reactive thermoplastic particles on a first surface of the reinforcement material reside in the oven; and
a conveyor belt wherein residence time that the reactive thermoplastic particles on the first surface of the reinforcement material is based on the conveyor belt's rate.

22. The apparatus of claim 21, wherein the belt rate is between about 1 meters per minute and about 4 meters per minute.

23. The apparatus of claim 21, wherein the residence time that the reactive thermoplastic particles on a first surface of the reinforcement material reside in the oven is between about 1 min. and about 5 min.

24. The apparatus of claim 22, wherein the reactive thermoplastic material is selected from the group consisting of reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

25. The apparatus of claim 24, wherein a shape of the thermoplastic resin is selected from the group consisting of a granule, pellet, flake, pastille, needle, chunks, and a chip.

26. The apparatus of claim 24, wherein the porous substrate is a reinforcement material selected from the group consisting of carbon fiber, glass fiber, basalt fiber, and polymer fiber.

27. The apparatus of claim 26, wherein the reinforcement material is in a form selected from the group consisting of roving, tape, web, weave, bi- or -multi-axial fabrics, knit, braid, random mat, and fleece.

28. The apparatus of claim 24, wherein the temperature is between about 190° C. and about 220° C. and the residence time is between about 1 and 5 minutes.

29. The apparatus of claim 24, wherein a weight of the reinforcement material per surface area of the reinforcement material is between about 200 g/m² and about 2,000 g/m² and a weight percent of the reactive thermoplastic is between about 30% to about 80%, based on a weight of the reactive polymer pre-impregnated reinforcement material.

30. The apparatus of claim 24, wherein the temperature is 190° C. and the residence time is less than or equal to 1 minute.

31. The apparatus of claim 24, wherein a weight of the reinforcement material per surface area of the reinforcement material is about 460 g/m² and a weight percent of the reactive thermoplastic is between about 34% to about 35%, based on a weight of the reactive polymer pre-impregnated reinforcement material.

32. The apparatus of claim 24, wherein a weight of the reinforcement material per surface area of the reinforcement material is about 620 g/m² and a weight percent of the reactive thermoplastic is between about 33% to about 36%, based on a weight of the reactive polymer pre-impregnated reinforcement materials.

33. The apparatus of claim 24, wherein a weight of the reinforcement material per surface area of the reinforcement material is about 810 g/m² and a weight percent of the reactive thermoplastic is between about 34% to about 36%, based on a weight of the reactive polymer pre-impregnated reinforcement material.

34. The apparatus of claim 24, wherein the reactive thermoplastic particles have a thickness between 0.5 mm and 3 mm and a diameter between 1 mm and about 8 mm.

35. The apparatus of claim 24, wherein the reactive thermoplastic particles have a diameter between about 1 mm to about 8 mm and a length between about 1 mm and about 8 mm.

36. The apparatus of claim 24, wherein the reactive thermoplastic particles are made from macrocyclic oligomeric butyleneterephthalate.

37. The apparatus of claim 37, wherein the reactive thermoplastic particles have a diameter between about 1 mm and about 5 mm and a length between about 1 mm and about 8 mm.

38. The apparatus of claim 24, comprising:
a belt press after the thermal convection oven, wherein the belt press has a hot zone and a cold zone,
wherein the hot zone is adapted to receive drapable polymer pre-impregnated reinforcement material and to heat said pre-impregnated reinforcement material to less than or equal to 250° C. and greater than or equal to 1 bar pressure, and
wherein the cold zone is adapted to receive a fully impregnated and cured thermoplastic composite sheet and to cool said fully impregnated and cured thermoplastic composite sheet to 25° C.

39. A method for forming a thermoplastic composite sheet, comprising:
providing a feeder roll of reinforcement material, a receiver roll of drapable polymer pre-impregnated reinforcement material and a conveyor belt having the reinforcement material from the feeder roll thereon,
wherein the reinforcement material has a fiber content based on total weight of the thermoplastic composite sheet;
providing a particle deposition hopper charged with reactive thermoplastic particles and adapted to deposit between 240 g/m² and about 470 g/m² of the reactive thermoplastic particles, based on the surface area (m²) of the reinforcement material;
providing a thermal convection oven adapted to substantially uniformly maintain the reactive thermoplastic particles on a first surface of the reinforcement material between about 190° C. and about 220° C. during a residence time that the reactive thermoplastic particles on a first surface of the reinforcement material reside in the oven;
providing a conveyor belt wherein residence time that the reactive thermoplastic particles on the first surface of the reinforcement material is based on the conveyor belt's rate; and
providing a belt press after the thermal convection oven, wherein the belt press has a hot zone and a cold zone,
wherein the hot zone is adapted to receive drapable polymer pre-impregnated reinforcement material and to heat said pre-impregnated reinforcement material to less than or equal to 250° C. and greater than or equal to 1 bar pressure, and
wherein the cold zone is adapted to receive a fully impregnated and cured thermoplastic composite sheet and to cool said fully impregnated and cured thermoplastic composite sheet to 25° C.

40. Forming a composite according to the method of claim 39, wherein the fiber content of the reinforcement material is between about 50% and about 70% by weight, based on a weight of the thermoplastic composite.
